(19) United States
(12) Patent Application Publication
(10) Pub. No.: US 2015/0131325 A1
(43) Pub. Date: May 14, 2015

(54) DISPLAY DEVICE

(71) Applicant: Mitsubishi Electric Corporation, Tokyo (JP)

(72) Inventor: Takafumi KOKUSHO, Tokyo (JP)

(73) Assignee: MITSUBISHI ELECTRIC CORPORATION, Tokyo (JP)

(21) Appl. No.: 14/522,794

(22) Filed: Oct. 24, 2014

(30) Foreign Application Priority Data
Nov. 12, 2013 (JP) 2013-233782

(51) Int. Cl. G02F 1/1333; F21V 8/00

(52) U.S. Cl. CPC G02F 1/133308; G02B 6/0081; G02F 2001/13332; G02F 2001/133311; G02F 2001/133314
USPC 362/633

(57) ABSTRACT

A display device includes a display element, a planar light source device disposed on an opposite side of a display surface of the display element, a protective plate disposed on a display surface side of the display element, and a black frame member covering a peripheral edge part on a front surface of the protective plate, sandwiching the protective plate from both sides in a thickness direction, and having a decorated front surface.

### BACKGROUND OF THE INVENTION

1. Field of the Invention

The present invention relates to a display device, and particularly to a protective plate disposed on a front surface of the display device.

2. Description of the Background Art

Conventionally, a protective plate for improving strength is disposed on a front surface of a display device. Decorative printing, such as a black frame, is performed on the protective plate to improve design property of the display device (see, for example, Japanese Patent Application Laid-Open No. 2008-216939 and Japanese Patent Application Laid-Open No. 2012-93667). Further, there is a case where printing of a logo of a corporate name or the like is performed on the protective plate.

Usually, in the protective plate, in order to prevent scratches and chipping and to enhance appearance, the decorative printing has been performed not only on the front surface of the protective plate but also on a rear surface thereof. Further, there has been a case where design property of the display device is improved by sticking a film, on which the decorative printing has been performed, onto the front surface of the protective plate.

In the case of performing printing on the protective plate, there has been a case where a printing process is required in a production process of the protective plate and defects occur in the printing process. With this configuration, there has been a case where the protective plate subjected to a surface treatment for improving strength and improving optical characteristics is wasted. Further, in the case of sticking the film as well, there has been a case where defects occur in the sticking process and a member, such as a film, is wasted.

### SUMMARY OF THE INVENTION

An object of the present invention is to provide a display device capable of solving waste of a member resulting from decorative printing onto a protective plate and sticking of a film, on which decorative printing has been performed, thereto.

A display device according to the present invention includes: a display element; a planar light source device disposed on an opposite side of a display surface of the display element; a protective plate disposed on a display surface side of the display element; and an outer frame member covering a peripheral edge part on a front surface of the protective plate, sandwiching the protective plate from both sides in a thickness direction, and having a decorated front surface.

Since the display device includes the outer frame member covering the peripheral edge part on the front surface of the protective plate, sandwiching the protective plate from both sides in the thickness direction, and having the decorated front surface, decorative printing on the protective plate is not needed. Further, it is not necessary to stick a film, on which decorative printing has been performed, to the protective plate. Therefore, waste of a member resulting from the decorative printing onto the protective plate and sticking of the film, on which decorative printing has been performed, thereto can be eliminated.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a perspective view of a display device according to a first preferred embodiment;

FIG. 2 is a perspective view of a state in which the display device is partially exploded;

FIG. 3 is an exploded perspective view of the display device;

FIG. 4 is a perspective view of a protective plate;

FIG. 5 is a front view of the protective plate;

FIG. 6 is a rear view of a black frame member;

FIG. 7 is a rear view of a state in which the black frame member is disposed on the protective plate;

FIG. 8 is a front view of the display device;

FIG. 9 is a rear view of the display device;

FIG. 10 is a cross-sectional view taken along a line X-X in FIG. 8;

FIG. 11 is a rear perspective view of the display device;

FIG. 12 is a rear perspective view of the black frame member;

FIG. 13 is a main part enlarged view of a rear surface of the black frame member;

FIG. 14 is a front view of a protective plate of a display device according to a first variation of the preferred embodiment;

FIG. 15 is a front view of another protective plate of the display device according to the first variation of the preferred embodiment;

FIG. 16 is a rear perspective view of a black frame member of the display device according to the first variation of the preferred embodiment; and

FIG. 17 is a cross-sectional view illustrating a state in which a fitting projecting portion of the black frame member is fitted into a fitting recessed portion of the protective plate.

### DESCRIPTION OF THE PREFERRED EMBODIMENTS

### Preferred Embodiment

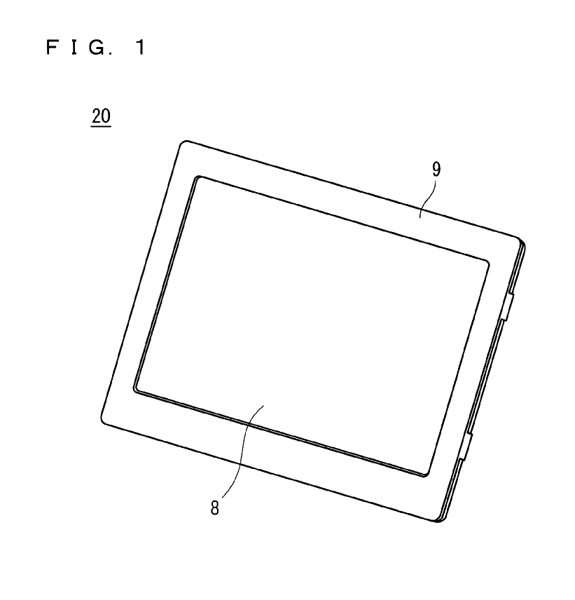

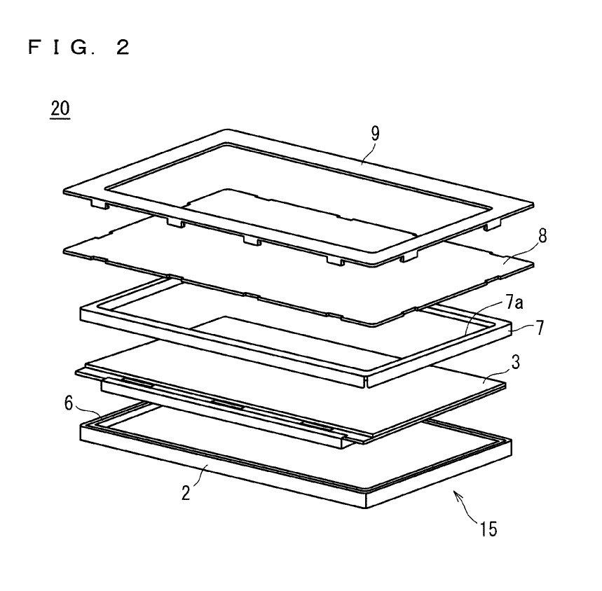

A preferred embodiment of the present invention will be described below by using the drawings. FIG. 1 is a perspective view of a display device 20 according to a first preferred embodiment of the present invention, FIG. 2 is a perspective view of a state in which the display device 20 is partially exploded, and FIG. 3 is an exploded perspective view of the display device 20.

As illustrated in FIGS. 1 to 3, the display device 20 includes a display element 3, such as a liquid crystal panel, a planar light source device 15, a front frame 7, a protective plate 8, and a black frame member 9 (outer frame member).

First, the planar light source device 15 will be described. The planar light source device 15 includes a point-like light source 10 emitting light, a light guide plate 1, a reflection sheet 5, optical sheets 4, an intermediate frame 6, and a rear frame 2. The planar light source device 15 is configured in such a manner that the rear frame 2 and the intermediate frame 6 sandwich the light guide plate 1, the reflection sheet 5, and the optical sheets 4.

The light guide plate 1 is formed in a rectangular shape in a front view and in a flat plate shape, and a material, such as transparent acrylic resin, polycarbonate resin, or glass, is used therefor. The light guide plate 1 is disposed on a front side of the rear frame 2 having an opening part 2a. The light guide plate 1 emits light emitted from the point-like light source 10 in a direction of the opening part 2a, and the direction is referred to as “emitting direction”. The light guide plate 1 includes an emitting surface 1a emitting light, an opposite emitting surface lb serving as an opposite surface of the emitting surface 1a, and side surfaces vertical to the emitting surface 1a and the opposite emitting surface 1b and connecting the emitting surface la and the opposite emitting surface 1b. Here, the light guide plate 1 includes a pair of side surfaces 1c, 1d formed in flat plate shapes and facing each other.

A light scattering part (not illustrated) for scattering a propagation direction of light and guiding the light from the emitting surface 1a to an emitting direction is formed on the opposite emitting surface lb of the light guide plate 1. The light scattering part functions as means of reflecting the light toward an inside of the light guide plate 1. The light scattering part is formed by using a method of performing dot printing on the opposite emitting surface 1b, a method of roughening the opposite emitting surface 1b and forming an embossed surface, a method of forming small spherical surfaces or irregularities, or the like. It should be noted that a type, an arrangement position, and the like of the light guide plate 1 can be appropriately selected. Further, a flat plate is used as the light guide plate 1 in the present preferred embodiment, but a wedge-shaped plate may be used.

The point-like light source 10 is disposed on the side surface 1c or the side surface 1d in the light guide plate 1. It should be noted that a type, an arrangement position, and the like of the light source can be appropriately selected. The optical sheets 4, such as a lens sheet and a diffusion sheet diffusing light, are disposed on the emitting surface la side of the light guide plate 1. The reflection sheet 5 is disposed on the opposite emitting surface lb side of the light guide plate 1. The intermediate frame 6 is formed of a resin material or a metal material, and holds the display element 3.

The reflection sheet 5 is formed of a material obtained by mixing polyethylene or polyethylene terephthalate with barium sulfate or titanium oxide, a material obtained by forming fine bubbles on a resin, a material obtained by depositing silver on a metal plate, or a material obtained by applying a coating material containing titanium oxide to a metal plate. It is desirable that a reflectance of the reflection sheet 5 be 90% or more to suppress reflection loss on a reflection surface, and the reflection sheet 5 may be formed of a material performing specular reflection. By disposing the reflection sheet 5, the light reaching the reflection sheet 5 from the light guide plate 1 is again directed to the light guide plate 1 and can be incident on the light guide plate 1. Accordingly, utilization efficiency of the light can be improved.

The rear frame 2 is disposed on a rear surface side of the light guide plate 1, at which the point-like light source 10 is disposed. In the case where the point-like light source 10 is used as a light source, heat dissipation of the point-like light source 10 can be further enhanced by forming the rear frame 2 using a metal material, such as aluminum. With this configuration, loss of light is suppressed, and light utilization efficiency of the planar light source device 15 can be enhanced. As a result, in the present preferred embodiment, the rear frame 2 is formed of the metal material.

As described above, the optical sheets 4 are disposed by combining the lens sheet, the diffusion sheet and the like. Here, various structures can be adopted as the optical sheets 4. For example, a structure which sandwiches the lens sheet with the diffusion sheets may be adopted as the optical sheets 4. Further, a plurality of lens sheets appropriately combining prism directions may be used to improve luminance. In a case of improving diffuseness of the diffusion sheet, two or more diffusion sheets may be used. On the other hand, in the case where it is not necessary to improve diffuseness of the diffusion sheet, only one diffusion sheet may be used, or the diffusion sheet can be omitted. Moreover, a protective sheet, a viewing angle control sheet, or a polarization reflecting sheet may be used as the optical sheets 4. In other words, the optical sheets 4 can be combined according to the required luminance and light distribution characteristics.

Next, the display element 3 will be described. In a state in which the display element 3 is held by the intermediate frame 6, the display element 3 is sandwiched between the front frame 7 and the planar light source device 15. The protective plate 8 is disposed on a display surface side of the display element 3, and a black frame member 9 forming a design housing is disposed on a front surface of the protective plate 8.

A liquid crystal panel applying birefringence of a liquid crystal material, a display panel in which a character or a picture is printed on a transparent plate, or the like is used as the display element 3. The liquid crystal panel includes a color filter substrate and a TFT substrate. The color filter substrate is a substrate on which a color filter, a light shielding layer, a counter electrode and the like are formed, and a TFT substrate is a substrate on which a thin film transistor (referred to as “TFT” hereinafter) serving as a switching element, a pixel electrode and the like are formed. The color filter substrate and the TFT substrate are disposed in a state in which they are opposite to each other.

The liquid crystal display panel further includes a spacer for holding a space between the color filter substrate and the TFT substrate, a seal material for bonding together the color filter substrate and the TFT substrate, a liquid crystal layer sandwiched between the color filter substrate and the TFT substrate, and an oriented film orienting a liquid crystal, and a polarizing plate. The liquid crystal display panel controls orientation of the liquid crystal layer by turning a voltage on or off by the switching element, and modulates the light incident on the liquid crystal display panel according to an image signal, thereby performing display.

The front frame 7 includes an opening part 7a which enables visual recognition of the display surface of the display element 3 from outside. The front frame 7 is formed of, for example, a metal material, such as aluminum. Since the front frame 7 is formed of the metal material, rigidity of the display device 20 is improved. It should be noted that the front frame 7 can be omitted.

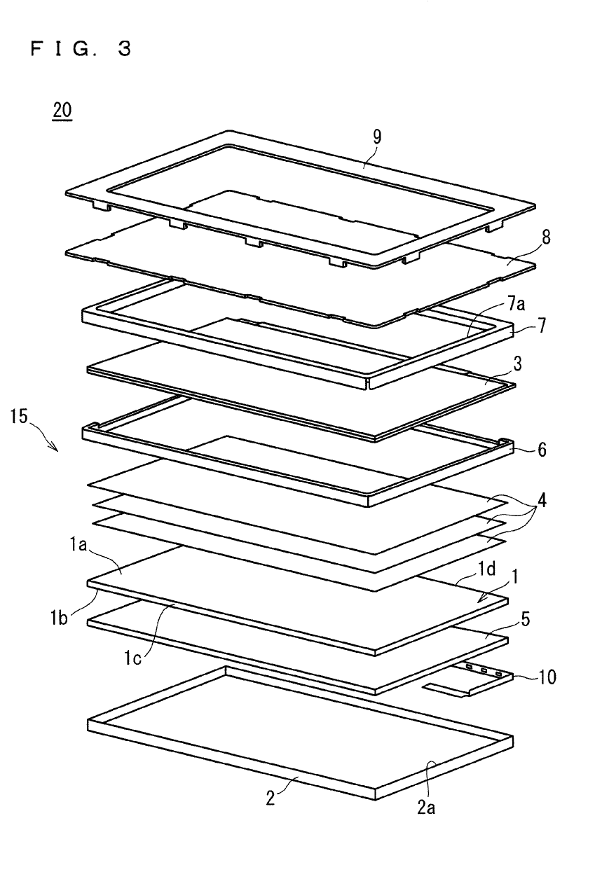

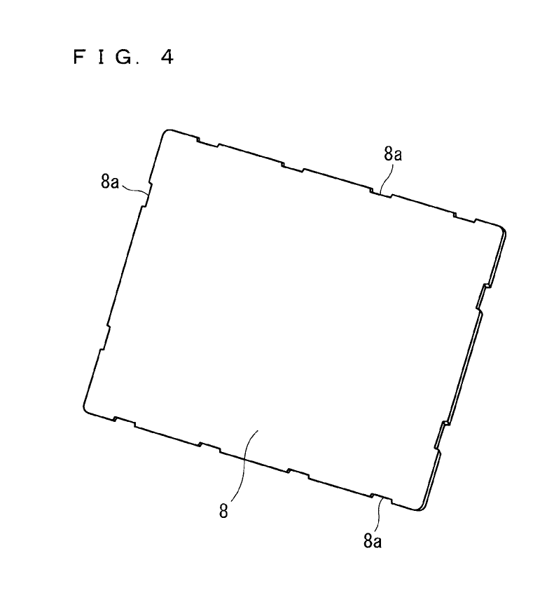

Next, the protective plate 8 will be described. FIG. 4 is a perspective view of the protective plate 8, and FIG. 5 is a front view of the protective plate 8. As illustrated in FIGS. 4 and 5, the protective plate 8 is formed in a rectangular shape in a front view and in a flat plate shape, and is disposed on the display surface side of the display element 3. With this configuration, strength of the display device 20 can be improved. Here, the protective plate 8 is optically adhered (bonded) to the display element 3 with an optical adhesive or the like. Further, it is also possible to include a low reflection layer by providing a chemical processing layer on a surface of the protective plate 8.

The protective plate 8 is formed of, for example, glass, and is subjected to chemical strengthening or thermal tempering by air jets as needed. A material, a thickness and a configuration of the protective plate 8 are selected appropriately and freely according to a required strength and characteristics. The protective plate 8 may be formed of, for example, a resin material.

A plurality of engagement recessed portions 8a is formed at peripheral edge part of the protective plate 8. The engagement recessed portion 8a is used when fixing the black frame member 9, and is formed into a shape which is recessed in a center direction from the peripheral edge part of the protective plate 8.

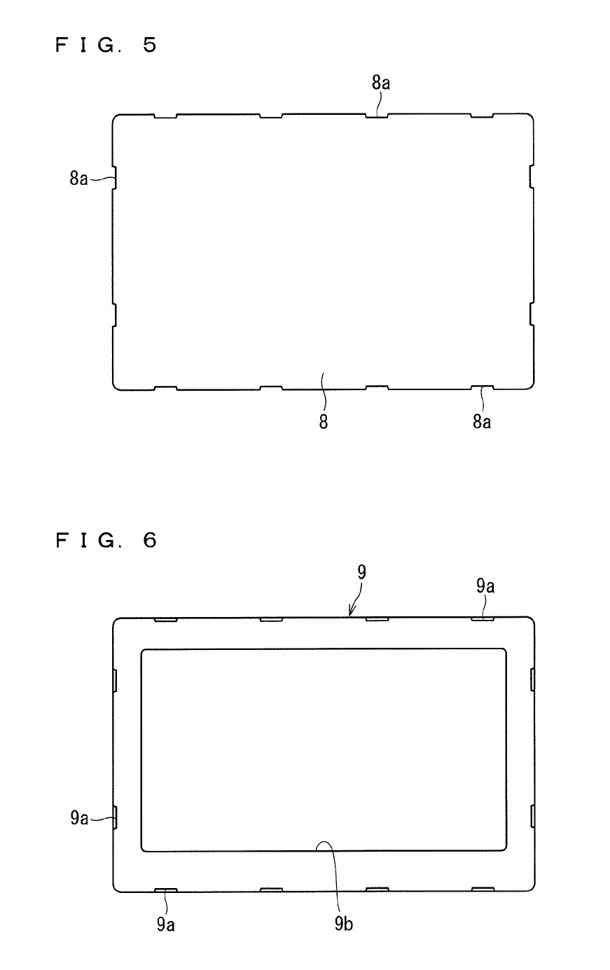

Next, the black frame member 9 will be described. FIG. 6 is a rear view of the black frame member 9. As illustrated in FIG. 6, the black frame member 9 is formed in a rectangular frame shape, and is disposed on the front surface of the protective plate 8. With this configuration, the black frame member 9 covers the peripheral edge part on the front surface of the protective plate 8. Further, decoration is applied to a front surface of the black frame member 9. More specifically, since the black frame member 9 is formed by mixing, for example, with black colorant, the entire black frame member 9 is colored in black. It should be noted that various colors and shapes can be adopted by the black frame member 9 serving as an outer frame member and can be selected appropriately and freely according to design property of the display device 20.

The black frame member 9 includes a plurality of engagement pawl portions 9a engaging with the engagement recessed portions 8a of the protective plate 8, and an opening part 9b which enables visual recognition of a display region of the display element 3. Here, the display region of the display element 3 is a region excluding the peripheral edge part of the display element 3. The black frame member 9 is formed of, for example, a resin material, such as an ABS resin. The material of the black frame member 9 is selected appropriately and freely according to required surface treatment, characteristics and the like.

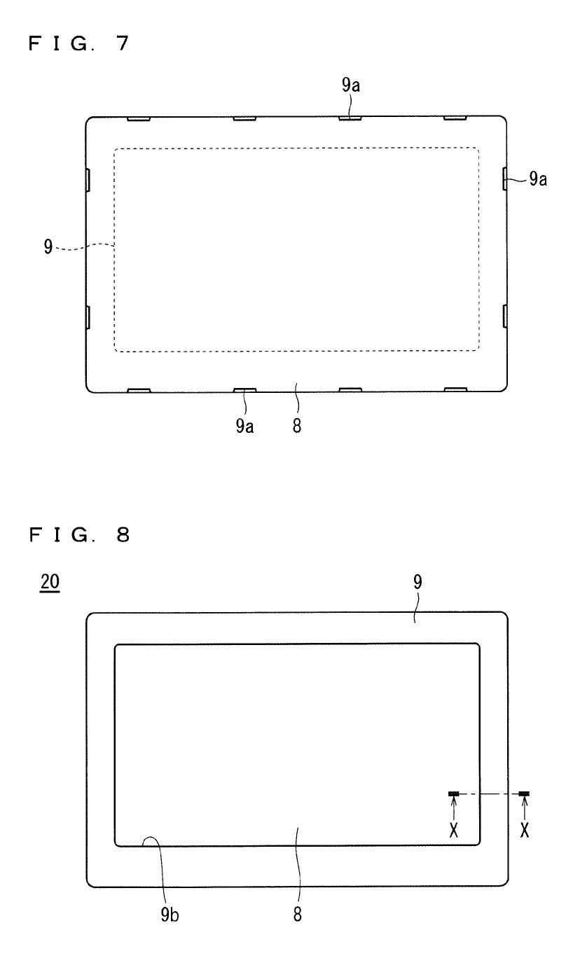

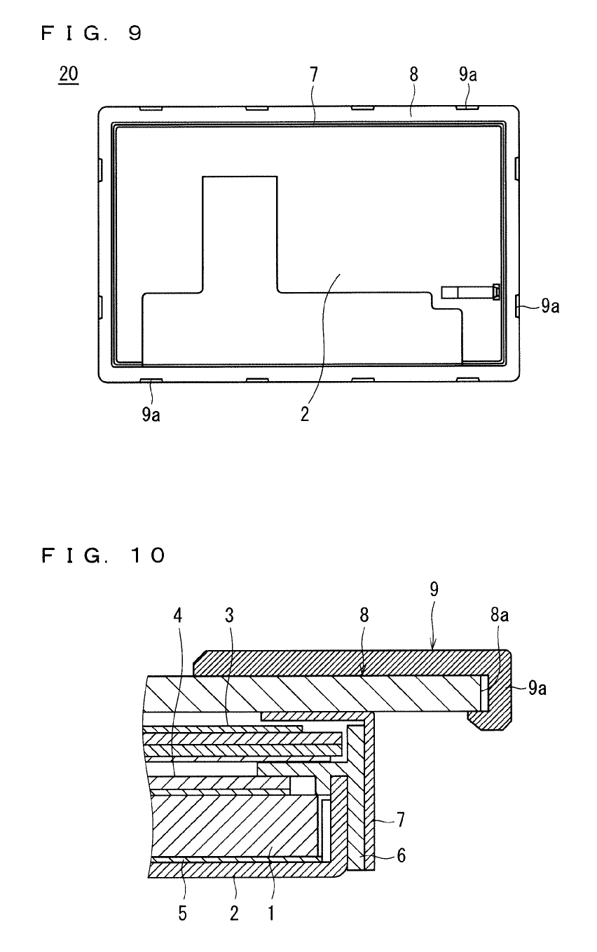

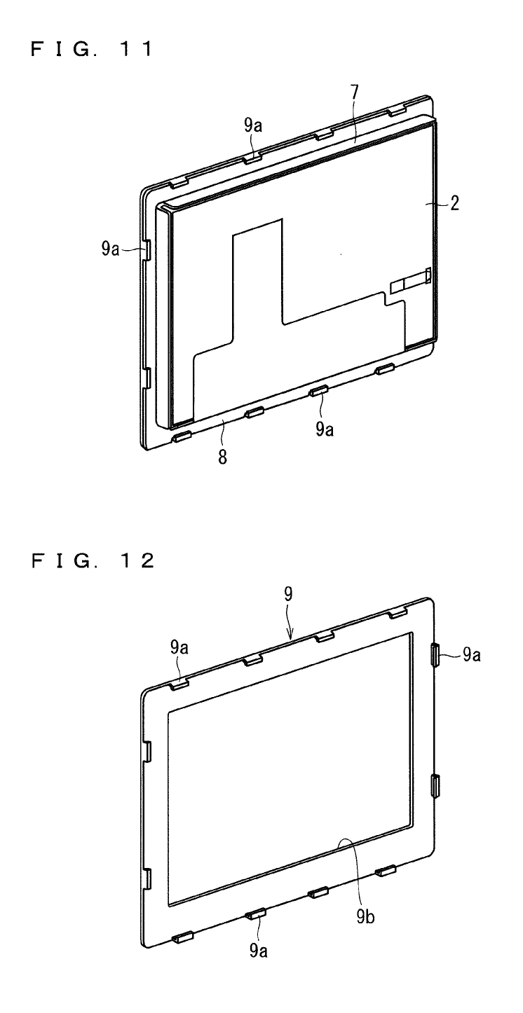

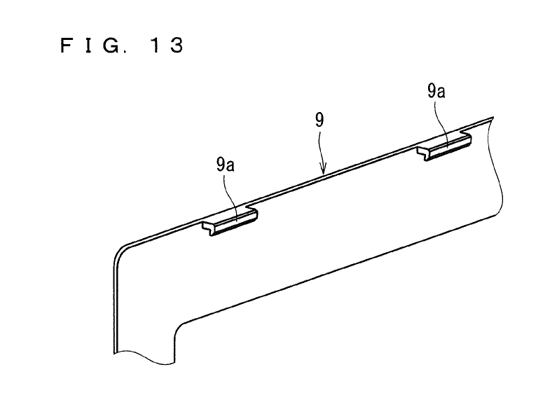

Next, fixing of the black frame member 9 and the protective plate 8 will be described. FIG. 7 is a rear view of a state in which the black frame member 9 is disposed on the protective plate 8, FIG. 8 is a front view of the display device 20, FIG. 9 is a rear view of the display device 20, FIG. 10 is a cross-sectional view taken along a line X-X in FIG. 8, FIG. 11 is a rear perspective view of the display device 20, FIG. 12 is a rear perspective view of the black frame member 9, and FIG. 13 is a main part enlarged view of a rear surface of the black frame member 9.

As illustrated in FIGS. 7 to 13, the engagement pawl portion 9a is formed at the black frame member 9 at a position corresponding to the engagement recessed portion 8a. The engagement pawl portion 9a is formed in a hook shape and has a structure engaging with the engagement recessed portion 8a of the protective plate 8. More specifically, in a state in which a base side part of the engagement pawl portion 9a is fitted into the engagement recessed portion 8a, a tip end of the engagement pawl portion 9a presses by its elastic force a peripheral part of the engagement recessed portion 8a on a rear surface of the protective plate 8. As a result, the engagement pawl portion 9a engages with the engagement recessed portion 8a. Then, as the engagement pawl portion 9a engages with the engagement recessed portion 8a, the black frame member 9 sandwiches the protective plate 8 from both sides in a thickness direction. Since the decorated black frame member 9 is fixed to the protective plate 8, design property of the display device 20 can be improved without performing decorative printing onto the protective film 8 or sticking a film, on which decorative printing has been performed, thereto.

As described above, since the display device 20 according to the preferred embodiment includes the black frame member 9 which covers the peripheral edge part on the front surface of the protective plate 8, sandwiches the protective plate 8 from both sides in the thickness direction, and has the decorated front surface, decorative printing to the protective plate 8 is not needed. Further, it is not necessary to stick the film, on which decorative printing has been performed, to the protective plate 8. Therefore, waste of a member resulting from the decorative printing onto the protective member 8 and sticking of the film, on which the decorative printing has been performed, thereto can be eliminated.

Conventionally, in the case where decorative printing is performed on a protective plate, when defects occur in the printing process of the protective plate, the protective member is wasted. Since the protective plate which has been subjected to a surface treatment for improving strength and improving optical characteristics is expensive, loss resulting from occurrence of defects in the protective plate has been large. On the contrary, in the display device 20, since the decorative printing to the protective plate 8 is not needed, occurrence of defects in the protective plate 8 can be suppressed, and a yield of the protective plate 8 can be improved. With this configuration, loss resulting from the occurrence of defects in the protective plate 8 can be reduced.

Conventionally, in the case where a protective plate, on which decorative printing has been performed, is stuck onto a front surface of a display element with an optical adhesive, there has been a case where bubbles are generated between the optical adhesive and the protective plate with a level difference between a printed layer applied to the protective plate and the protective plate as a starting point. In the display device 20, since the decorative printing to the protective plate 8 is not needed, a level difference resulting from printing performed on the rear surface of the protective plate 8 is not generated, and generation of bubbles can be suppressed.

As described above, since the decorative printing to the protective plate 8 is not needed and the film, on which the decorative printing has been performed, need not be stuck to the protective plate 8, the protective plate 8 is recovered from a product and can be recycled and reused.

Since the color and the configuration of the black frame member 9 can be selected appropriately and freely according to the design property of the display device 20, design according to a use of the display device 20 can be realized by replacing the black frame member 9.

The engagement recessed portions 8a are formed at the peripheral edge part of the protective plate 8, the black frame member 9 includes the engagement pawl portions 9a engaging with the engagement recessed portions 8a, and sandwiching by the black frame member 9 is performed by engaging the engagement pawl portions 9a with the engagement recessed portions 8a. Therefore, the black frame member 9 can be easily attached to or removed from the protective plate 8. In other words, disassembling property of the display device 20 can be enhanced. Accordingly, a degree of freedom of the black frame member 9 is enhanced, and the color and the configuration of the black frame member 9 can be easily changed while the protective plate 8 is disposed as it is.

Since the black frame member 9 is fixed to the protective plate 8 by its elastic deformation, even in the case where removal of the black frame member 9 is needed, the black frame member 9 can be used repeatedly. Since the protective plate 8 is optically bonded to the display element 3, light loss of the bonded surface between the protective plate 8 and the display element 3 can be reduced.

### First Variation of Preferred Embodiment

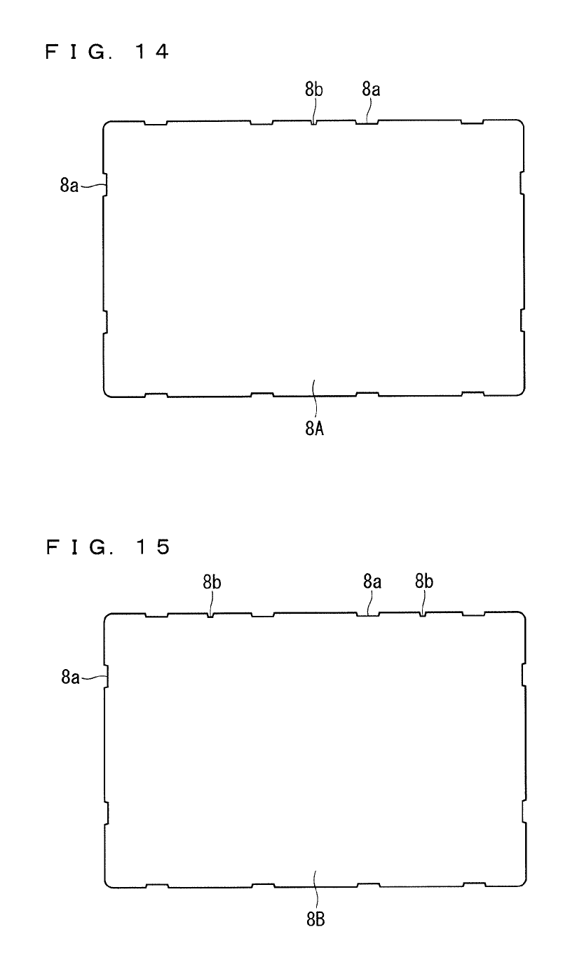

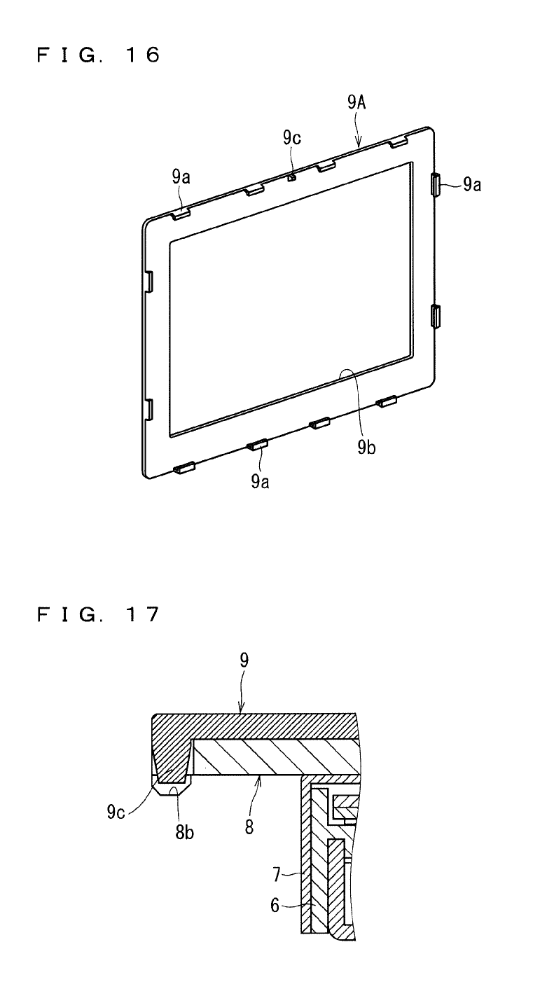

Next, a display device according to a first variation of the preferred embodiment will be described. FIG. 14 is a front view of a protective plate 8A of the display device according to the first variation of the preferred embodiment, FIG. 15 is a front view of another protective plate 8B of the display device according to the first variation of the preferred embodiment, FIG. 16 is a rear perspective view of a black frame member 9A of the display device according to the first variation of the preferred embodiment, and FIG. 17 is a cross-sectional view illustrating a state in which a fitting projecting portion 9c of the black frame member 9A is fitted into a fitting recessed portion 8b of the protective plate 8A.

By changing a part of a configuration of the protective plate, it is possible to perform positioning of the protective plate and the black frame member. For example, as illustrated in FIG. 14, the one fitting recessed portion 8b is formed at a peripheral edge part of the protective plate 8A. More specifically, the fitting recessed portion 8b is formed between two adjacent engagement recessed portions 8a at the peripheral edge part of the protective plate 8A. Further, as illustrated in FIG. 16, the fitting projecting portion 9c is formed on a rear surface of the black frame member 9A at a position corresponding to the fitting recessed portion 8b. As illustrated in FIG. 17, the fitting recessed portion 8b is formed deeper than a length from a base end to a tip end of the fitting projecting portion 9c. By fitting the fitting projecting portion 9c into the fitting recessed portion 8b, positioning at the time of mounting the black frame member 9A to the protective plate 8A can be performed.

It should be noted that the number of the fitting recessed portions 8b can be appropriately changed. For example, as illustrated in FIG. 15, the two fitting recessed portions 8b may be formed at a peripheral edge part of the protective plate 8B. In this case, the two fitting projecting portions 9c are formed on the rear surface of the black frame member at positions corresponding to the two fitting recessed portions 8b.

As described above, in the display device according to the first variation of the preferred embodiment, the fitting recessed portion 8b is formed at the peripheral edge part of the protective plate 8A, the black frame member 9A includes the fitting projecting portion 9c fitted into the fitting recessed portion 8b, and positioning of the black frame member 9A with respect to the protective plate 8A is performed by fitting the fitting projecting portion 9c into the fitting recessed portion 8b. Therefore, the positioning at the time of mounting the black frame member 9A to the protective plate 8A can be accurately performed, and mounting accuracy of the black frame member 9A with respect to the protective plate 8A is improved.

### Second Variation of Preferred Embodiment

Next, a display device according to a second variation of the preferred embodiment will be described. Here, description will be given using FIGS. 12 and 13 used in the description of the preferred embodiment. As illustrated in FIGS. 12 and 13, a pressure-sensitive adhesive (not illustrated) serving as an adhesive is disposed at a flat surface part of a black frame member 9 abutting a protective plate 8. Here, the flat surface part is formed over an entire area of a rear surface of the black frame member 9. The pressure-sensitive adhesive may be disposed over the entire area of the flat surface part, or may be disposed at a part of the flat surface part (e.g., two places on respective four sides of the black frame member 9). With this configuration, since the black frame member 9 can be firmly fixed to the protective plate 8, deviation of the black frame member 9 with respect to the protective plate 8 can be further suppressed.

Further, a recessed portion (not illustrated) is formed at a part of the flat surface part (e.g., two places on the respective four sides of the black frame member 9), and the pressure-sensitive adhesive may be disposed at the recessed portion. In this case, a clearance between the protective plate 8 and the black frame member 9 can be eliminated, and appearance of the display device is improved.

While the invention has been shown and described in detail, the foregoing description is in all aspects illustrative and not restrictive. It is therefore understood that numerous modifications and variations can be devised without departing from the scope of the invention.

What is claimed is:

1. A display device comprising:
a display element;
a planar light source device disposed on an opposite side of a display surface of said display element;
a protective plate disposed on a display surface side of said display element; and
an outer frame member covering a peripheral edge part on a front surface of said protective plate, sandwiching said protective plate from both sides in a thickness direction, and having a decorated front surface.

2. The display device according to claim 1, wherein an engagement recessed portion is formed at a peripheral edge part of said protective plate,
said outer frame member includes an engagement pawl portion engaging with said engagement recessed portion, and
sandwiching by said outer frame member is performed by engaging said engagement pawl portion with said engagement recessed portion.

3. The display device according to claim 1, wherein a recessed portion is formed on a rear surface of said outer frame member, and an adhesive for fixing said protective plate is disposed at said recessed portion.

4. The display device according to claim 1, wherein a fitting recessed portion is formed at the peripheral edge part of said protective plate,
said outer frame member includes a fitting projecting portion fitted into said fitting recessed portion, and
positioning of said outer frame member with respect to said protective plate is performed by fitting said fitting projecting portion into said fitting recessed portion.

5. The display device according to claim 1, wherein said protective plate is optically bonded to said display element.
